(19) United States
(12) Patent Application Publication
(10) Pub. No.: US 2009/0102844 A1
(43) Pub. Date: Apr. 23, 2009

(54) METHOD FOR SYNTHESIZING A VIRTUAL IMAGE BY BEAM LAUNCHING

(75) Inventor: Renaud Deparis, Paris (FR)

Correspondence Address: OSHA LIANG L.L.P., TWO HOUSTON CENTER, 909 FANNIN, SUITE 3500, HOUSTON, TX, 77010, US

(73) Assignee: REDWAY 3D, St. Cloud (FR)

(21) Appl. No.: 12/162,967

(22) PCT Filed: Feb. 1, 2007
(86) PCT No.: PCT/FR07/50726

§ 371 Date: Jul. 31, 2008

(30) Foreign Application Priority Data
Feb. 1, 2006 (FR) 06/00914

(51) Int. Cl. G06T 15/50; H04N 5/235

(52) U.S. Cl. 345/426; 348/251; 348/E05.034

(57) ABSTRACT

The invention concers a method for preparing a synthetic image of a scene from a camera, said scene comprising a plurality of objects defined by elementary meshes stored in a database, said method including: (a) a step of defining, via a central processing unit, a plurality of rays exiting from said camera towards said observed scene; (b) a step of processing said plurality of rays including: a sub-step (b4) of assembling the rays into beams; (c) a step of propagating said beams including: (d) a first step of determining, for each of said propagated beams, a subset of all the meshing elements which are intersected by said propagated beam; then (C2) a second step of calculating, via a graphics processing unit and for each of said propagated beams, intersections between the meshing elements of said subset and the rays of the propagated beams; (d) a step of generating said image of the scene following the propagating step.

This invention concerns the creation of realistic computer-generated images for tri-dimensional scenes, especially for computer-assisted design (CAD) applications, video games, simulation or cinematographic post production.

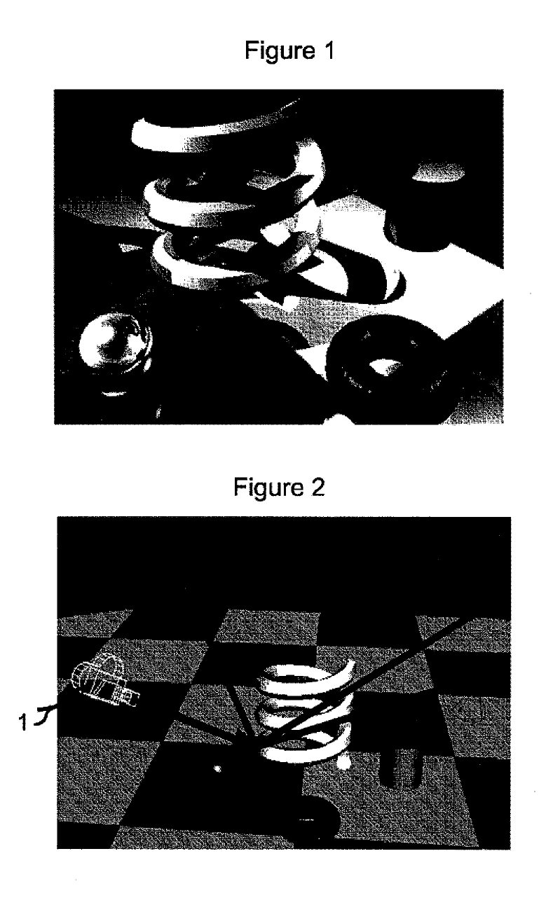

Tri-dimensional scenes, such as illustrated in FIG. 1, are generated by computer with meshes defining a multitude of 3D objects in the scene. The rendering of such scene from an eye-point is generated as an image (pixel matrix) and needs to take numerous parameters into account such as object illumination or nature (reflecting coat, light-transparent materials, etc.). The implementation of such renderings is complex.

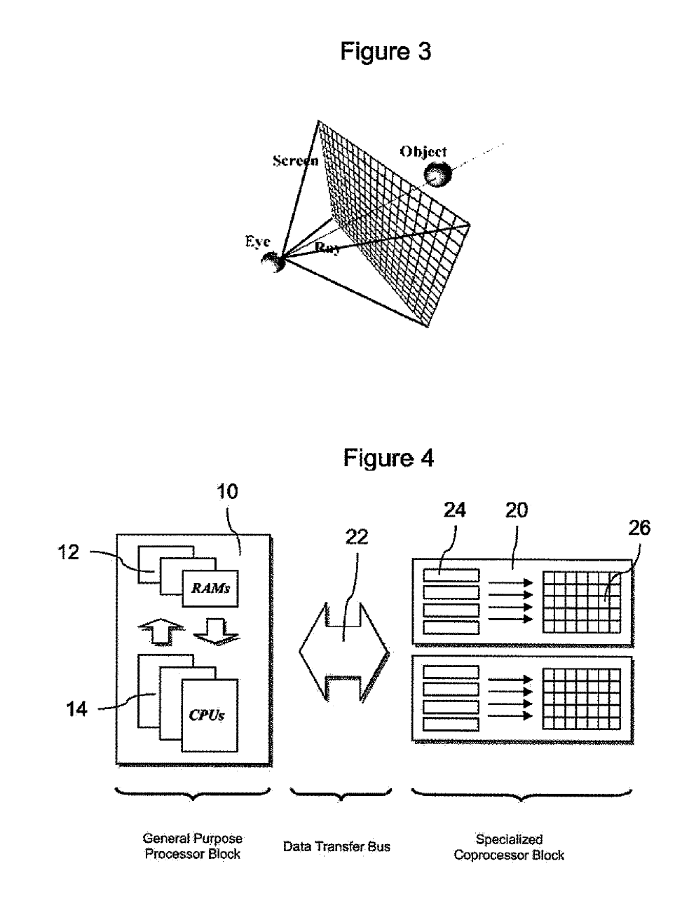

The use of ray tracing for computing object illuminations and shadows in such computer-generated images has been known since the late 70s. As illustrated in FIGS. 2 and 3, ray tracing consists in tracing a ray A produced from the scene eye-point 1 (the camera) towards the zone of each pixel of the image (computation according to the camera's aperture and the number of pixels making the final image) then studying all or part of the propagations of this ray on the various objects included in the scene to determine the color of the pixels. Practically, every primary ray A coming from camera 1 is propagated by reflection C, by transmission (not represented) or by diffusion towards a light source (shadow ray B). Each ray propagated by reflection or transmission is again propagated when it meets another object of the scene: these are the multiple propagations of a ray. Due to the nature of the materials making the objects hit by the ray, and from the presence of shadows, said rays enable to assess the color to be displayed for each pixel taking the casted shadow (rays B) and the materials of the objects seen by simple and multiple transmissions and reflections into account. According to the number of reflections, transmissions or light sources considered, the calculation of 10 rays per pixel is commonly reached. Therefore, we see that the number of rays to be calculated for a whole image is very large.

For many years and as described in U.S. Pat. No. 5,031,117, this algorithm was implemented only on central processing units (CPU), sometimes in parallel, producing very realistic renderings. Due to the intrinsic nature of ray tracing algorithm and CPU polyvalence, this technique requires high computation time.

On the other hand, graphic cards or graphics processing units (GPU) are efficient for processing simultaneously several pixels, using the z-buffer matrix (defined hereafter). Recent developments of these cards led to direct GPU ray tracing applications, as in patent application US 2005/0041024, or in scientific publication “Ray tracing on a stream processor” (Timothy John Purcell, Thesis report, Stanford University, March 2004). However, their performance remained limited fore obtained rendering, below what is expected for equivalent processing times performed on CPU.

An improvement over conventional ray tracing was introduced with the use of beams, described in the scientific publications “Beam tracing polygonal objects” (Paul S. Heckbert, SIGGRAPH '84, pp. 119-127, July 1984) and “Une synthese des variantes du lancer de rayons et du lancer de faisceaux” (A synthesis of ray tracing and beam tracing variants) (J-M Hasenfratz, Revue internationale de CFAO, Vol. 13, no 3, September 1998, pp. 235-264) especially referring to the previous publication by Heckbert. The adopted so-called “pencil” approach consists in adjoining to an axial ray its neighboring paraxial rays to cover broader zones in a single tracing. This approach was however set aside because experiments lead to conclude that beam tracing techniques are not cost effective and still present numerous problems.

It is however as certain that the players in computer-generated imagery (design centers, video games, post-production) are increasingly demanding as far as image computation time is concerned. Therefore, there is a great need for a solution to decrease such computation time while relying on current computing components. A solution was introduced by N. Carr, J. Hall et J. Hart (Illinois University) in their publication “The ray engine” (Graphics Hardware, 2002, pp. 1-10), where an integrated CPU-GPU architecture is used. The CPU is used to drive the general ray tracing algorithm and send requests to the GPU, which operates for massifiying the intersection calculation between rays and triangles in object meshes. The results obtained are comparable to the best CPUs dedicated to ray tracing. The improved GPU performances should even clearly increase these overall performances.

It appears that the GPU remains overloaded and limits the system performances. Current demands for virtual image generation require minimum interactivity (at least one image generated every few seconds). The current low-cost GPUs do not enable to obtain such performances for complex scenes (design, post-production). Hence, there is an underlying need to optimize ray tracing applications for such architectures.

This invention aims at presenting a solution to the limitations of the previous art. The invention relies on an integrated CPU-GPU architecture in which ray tracing optimization is provided by utilizing efficient beams and a distribution of the computation loads between the CPU and the GPU according to their own capability to access the memories (CPU) or treat in parallel numerous graphical data (GPU). The invention enables to group rays as beams according to spatial proximity criteria in order to decrease the propagation model to a number of beams much less than the total number of rays. This relies on the principle that rays which are a priori “near” are likely to meet the same objects and therefore to propagate “together” in the scene.

An optimization of this invention is to resolve the interaction of such propagated beams, not on the whole scene, but on part of it. For this purpose, the CPU pretreats the beams to determine a rough set of scene elements that will be intersected by the beam, then transmits this set to the GPU. Therefore, the required number of computational operations performed by the GPU clearly decreases compared to processing the intersection of one beam with all the elements of the scene, or of all the rays with all the elements of the scene.

To this effect, the invention has first for object a procedure for elaborating a computer-generated image of a scene from a camera, aforesaid scene including a plurality of objects defined by elementary meshes stored in a database, the procedure including
(a) a defining step, by a central processing unit, of a plurality of rays produced from aforesaid camera towards said observed scene;
(b) a processing step of said plurality of rays including
   a grouping sub-step (b4), eventually by said central unit, of rays into beams;
(c) a propagation step of said beams, including
   (c1) a first determination step, for each of said propagated beams, of a subset of all meshing elements that are intersected by said propagated beam; then
   (c2) a second calculation step, by a graphics processing unit and for each said propagated beam, the intersections between said subset meshing elements and the propagated beam rays;
(d) a generation step of said scene image following aforesaid propagation step.

“Camera” is understood as a generic term meaning the eye-point and the scene rendering. It can be the eye of an observer, the sensor of a video camera or of a photo camera.

Similarly, “meshing” involves the representation of a 3D shape from planar elements, for example triangles or quadrilaterals, or from surfaces such as NURBS (Nonuniform Rational B-Spline surface), Bezier surfaces, and polynomial surfaces.

“Defined” means the coordinates of each mesh element stored in the database. The object can be represented by triangles, where the coordinates of the triangle apex in the scene space are base stored.

The definition of the rays relies mainly on the notion of ray tracing previously covered. The definition of rays is assimilated to that of the final computer-generated image as matrix of pixels with set dimensions. Indeed, the rays generally match the eye-point and a pixel of the final image. The couple (eye-point, pixel direction) defines an example of ray. From this fact, when the CPU regroups the scene visualization parameters, i.e. the position of the camera, the visualization direction, the camera vertical and the visualization opening angle, the dimensions of the image to be generated directly define the plurality of rays.

In applying ray tracing, the rays, and more specifically the beams of this invention, enable to determine the visible meshing elements (partially visible in case of attenuation from shadow, reflection effect, etc.) and to infer from this the color characteristics of the pixels in the final image.

The term “propagated ray or beam” should be understood, as the case may be, as the ray or beam originating directly from the camera (primary ray), the shadow ray or beam (after reflection or not), the reflected ray or beam (one or several reflections), the transmitted ray or beam, the ray or beam used for computing or sampling an energy exchange between the meshing elements . . . originating from any optical principle governing the light optical trajectory.

As previously mentioned, the “GPU” or graphics processing unit is a specialized computer component used by the computer system to which it is connected to process the tracing of geometrical figures from graphic primitives (points, triangles, . . . ). The GPU is efficient to perform a same calculation over a large number of data. In this invention, it is opposed to the “CPU” or central processing unit which is a generalist component efficient for memory access and specific task processing, or for organizing data into structures.

In the solution proposed by the invention, the set subset of meshing elements includes, in any event, the meshing elements (hereafter indifferently mentioned as triangles or meshing elements) that intersect every ray of the beams. In this way, the calculations performed by the GPU on this subset are not skewed as compared to calculations on all meshing elements. Such elements are even notably optimized since a large number of requests on non-pertinent meshing elements is avoided. Thus, an acceleration factor of 10 for the calculations can easily be obtained.

The generation of the final computer-generated image resides in the color determination of each pixel. The propagated beams enable to determine for one visible object in one pixel of the image, the elements of the scene involved mainly either as shadow, or reflection, or transmission.

In one embodiment, said step of determination (c1) of said subset is performed by said central processing unit CPU connected to said database. The CPU operates according to its access capacities to the memory storing the database and to the random access memory in which it stores intermediary data. This provides an increased efficiency. Indeed, the conjunction of CPU/GPU parallelism, CPU processing speed for the determining the subset using fast access to the triangles data in memory, and decreased GPU load from processing a subset of triangles, insures an acceleration of the computer-generated image restitution by a factor above 10.

As mentioned above, the constitution of the mesh element subset offers an optimization of the calculation loads between the CPU and the GPU. To take advantage of the CPU memory access capabilities, the beams are structured in beam sections along the direction of propagation; these sections are supported by an accelerating structure as it already exists in prior art, especially “A survey of geometric data structures for ray tracing” (Allen Y. Chang, Oct. 13, 2001, PhD thesis report at Polytechnic University of Brooklyn, N.Y.). Then, said determination step (c1) of a mesh element subset includes a beam propagation sub-step according to an accelerating structure, and a determination structure for each said sections along the accelerating structure of said intersected meshing elements. Said subset of meshing elements is then constituted by the set of said meshing elements intersected by the beam along the accelerating structure.

The accelerating structure is a simple decomposition of the scene space, for example using a regular hierarchic voxel (volumetric pixels) basis, or a hierarchic basis of plans separating the space (kd-tree). The beam sections are then determined by the voxel frontiers along the beam propagation direction. Then for each beam section, the mesh triangles that cut the beam are determined.

On the other hand, an optimization of the solution for decreasing the number of calculations to be performed for tracing the set of rays consists in minimizing the number of rays. In this way, one can expect that, for a computer-generated image represented by a matrix of pixels, at most one ray is generated (mean calculated as the ratio of ray number over pixel number) per pixel crossing this pixel during said ray generation step (a).

In a variation mainly aiming at a better rendering, especially with regard to anti-aliasing, it can be provided that, for a computer-generated image represented by a matrix of pixels, a set of rays per pixel is generated, all crossing said pixel, during said ray generation step (a). This variation is realized at the expense of computation time.

The presence of several rays per pixel enables to fight in particular the aliasing introduced by pixel sampling on the scene. One can also consider replacing the ray crossing the pixel by a conical beam more or less matching the pixel shape, as already suggested in patent application PCT WO93/01561 or in previously cited scientific publication Hasenfratz98 (page 9, FIG. 3).

A significant part of the efficacy of this invention resides in using optimized ray beams. Hence, it appears important to provide an efficient method for generating such beams. To that end, said step of rays processing (b) includes, prior to sub-step (b4):
a generating sub-step (b1), by said graphics processing unit, of an identifier image of the scene in which, within each pixel, identification data are recorded for one or several meshing elements visible at this pixel;
a determining sub-step (b2), for each pixel of the identifier image, of at least one intersecting point of said primary ray(s) crossing the pixel with said mesh element(s) which identification data are recorded at the pixel coordinates of said image, when such identification data exist for said pixel;
eventually, a determining sub-step (b2′), for each pixel of the identifier image, of at least one re-emission direction of said primary ray(s) crossing the pixel with said mesh element(s) which identification data are within the pixel, when such identification data exist for said pixel;
A pixel assembling sub-step (b3) where said intersecting points previously determined are spatially coherent.

In addition, said beam assembling sub-step (b4) consists in assembling within a same beam the rays associated to the pixels assembled during said sub-step (b3).

The identifier image (primary if those are rays directly originating from the camera) generally has the same dimension as the final computer-generated image we intend to generate. However, we consider increasing the number of rays for studying the final image (and therefore the size of identifier images) in order to have a larger number of information for processing problems such as aliasing. The final image is then a sub-sample of such information.

For example, every pixel composing the pixel matrix of the image is given a color which value in RGB (Red-Green-Blue) code is equal to the identification data of the mesh element visible at this pixel. This image enables to have in a synthetically manner each of the meshing elements visible at every pixel, and thus to quickly collect identification data of meshing elements of the first obstacle met to begin the ray or beam tracing analysis. Such a tracing of the primary image by the graphics card, without considering lights, is very efficient: the GPU graphic card receives the coordinates of all the mesh triangles stored in the base from the CPU, and proceeds to tracing the image by conventional methods using in particular Z matrix (z-buffer—memory used to store the triangle identifier to be displayed for each pixel, and updated to only keep that triangle nearest to the camera) available for its use. To take advantage from this tracing pass for transparent element surfaces, it can be agreed to memorize for each pixel, the meshing elements intersected by the ray, that is the element directly visible and those potentially visible by transparence, for example by memorizing successively in the pixel color components the identifying data for the meshing elements in the order in which they are intersected.

For each pixel, the knowledge of the mesh element hit due to its identifying data in the image, and therefore of its definition parameters stored in the database, allows to easily compute (step b2) the intersecting point between the ray crossing the pixel (line) and the mesh element (plane). It is a simple resolution of a line-plane intersection.

An alternative could consist in having the graphics card GPU to perform directly the calculation of the intersections between rays and meshing elements, and having the pixels RGB color components of the identifier image to include directly the intersection coordinates of a ray with the meshing element, in which case step b2 is performed by the graphics card.

Another alternative could consist in having the graphics card GPU to perform the calculation of the ray length from the camera to the intersecting point of the nearest mesh element, and having the color component of the identifier image pixels to include this value (depth image of the z-buffer), in which case step b2 is performed by the CPU by calculating the point on the ray at the distance read in the identifier image.

The term “spatially coherent rays” is related to rays that are substantially parallel and which points of intersection with the mesh triangle nearest to the camera are near in space. The assembling of the spatially coherent rays enables to group, for common processing, the rays that more or less touch a same object (close intersecting points) in the space of the scene and with the same pitch angle (nearly parallel rays). “Substantially parallel” means rays originating from the camera in a substantially similar direction. In case of a numeric image made of pixels, these rays can be seen as those generated from the camera towards a defined zone of the image (e.g. a 32×32 pixels square). The rays among those of the defined zone having intersecting points with the scene meshing elements for which the distance is below a threshold value (for example the size of a voxel) can, for example, be considered spatially coherent. Among such rays, those having, in addition, directions which angle is below a threshold value (for example 10 degrees) can be considered substantially parallel. In this way, the beams create cones with regular (square, triangle) or irregular (any shape according to the rays under consideration) bases.

To optimize rays of homogenous size over the whole image, it is also provided to subdivide the total image in primary zones, for example 32×32 pixels, within which the ray assembling occurs.

Also in order to optimize these assemblings, the transmission or reflection (direction of re-emission of step b2′) information can be taken into consideration to subdivide spatially coherent beams in more efficient beams.

According to various laws of light ray propagation accounting for determining the pixel colors of the computer-generated image, said propagated beams include beams that are transmitted, and/or reflected, and/or of shadow and/or beams of diffuse interactions, and/or sampling beams of an energetic phenomenon related to light propagation.

According to the level of precision of the desired rendering, and therefore its realism, it may be interesting to analyze the contribution of multiple reflections and/or transmissions of the rays and beams on different objects of the scene. Indeed, in the presence of highly reflective surfaces, the beams are reflected numerous times until their attenuation becomes sufficient to neglect them. In this way, it can be provided that the propagation step of said beams (c) be recursively applied to each said beams transmitted, and/or reflected, and/or of shadow, and/or of interactions, and/or of sampling. Eventually, said beam generation step (b) can also be reproduced for each of these beams or for all of them.

Optimizations can also be brought to this approach. Especially, as soon as a beam attenuation percentage is reached, it stops being propagated: It is considered that the upstream beams provide enough color information for the final rendering of the pixel zone being considered. The other beams can be propagated until the same attenuation threshold is reached.

On the other hand, it may be beneficial to favor calculation speed over rendering, and consequently to limit the propagation of the transmitted and/or reflected rays to one, two, or three recurrences.

Specifically, the procedure can include, recursively, at each new propagation, a processing step of the rays propagated according to step (b) to assemble them in beams through said central unit (b4) and a propagation step of the beam according to steps (c1) and (c2). This allows for optimizing at each calculation step by using appropriate beams.

When a beam has been propagated several times by a same object, it can meet several obstacles (object meshing elements) during a n^{th} propagation. It may be agreed, in order to improve the efficiency of the ulterior processing, to consider differently the sub-beams which met the various obstacles. In this way, the procedure includes, when said intersections calculated during said calculation step (c2) are not spatially coherent, a division step (c3) of a beam propagated into sub-beams propagated by assembling the rays which intersections calculated at step (c2) are spatially coherent. This beam division into sub-beams is very similar, with regards to division criteria, to the assembling of rays in beams (step b3).

Also, after multiple propagations, e.g. transmission or reflection, one may face propagation problems, e.g. a wall corner hit by a beam and part of the rays is reflected in one direction by a wall side and the other part is reflected in a completely different direction by the other wall side. Therefore, the procedure also includes a division step (c3′) of a propagated beam, transmitted or reflected, presenting non-coherent rays in sub-beams.

Here, “non-coherent rays” means rays which direction vectors are not substantially parallel, i.e. their angle is for example above a threshold value or their starting points are spatially to far one from the others. This could also be the case for relief textures on which the reflection of the beam is highly disturbed, sometimes necessitating the subdivision of the beam into sub-beams.

The invention also has for object a computer software including a plurality of instructions capable to implement the procedure for elaborating a computer-generated image as previously described.

The invention also has for object a storage media that includes said computer software. The invention also has for object a system to implement the procedure. The system includes at least one central processing unit linked to at least one storage memory, and at least one graphics processing unit connected to said central processing unit through a bus,
said central processing unit includes means for generating (a) rays produced by said camera towards said observed scene, to assemble (b4) said rays into beams, to determine the propagation (c) of said beams, and to determine (c1), for each propagated beam, a subset of all the meshing elements intersected by said propagated beam;
said graphics processing unit including means for calculating (c2), for each of said propagated beams, the intersections between the meshing elements of said subset and said propagated rays, and to generate (d) an image of the scene using said propagated beams.

The invention will also become further apparent through the drawings, where

FIG. 1 represents a virtual scene including 5,000 mesh triangles for representing objects, virtual scene for which we would like to synthesize a computer-generated image through this invention;

FIGS. 2 and 3 illustrate ray propagation in a ray tracing process;

FIG. 4 represents an example of architecture system for implementing this invention;

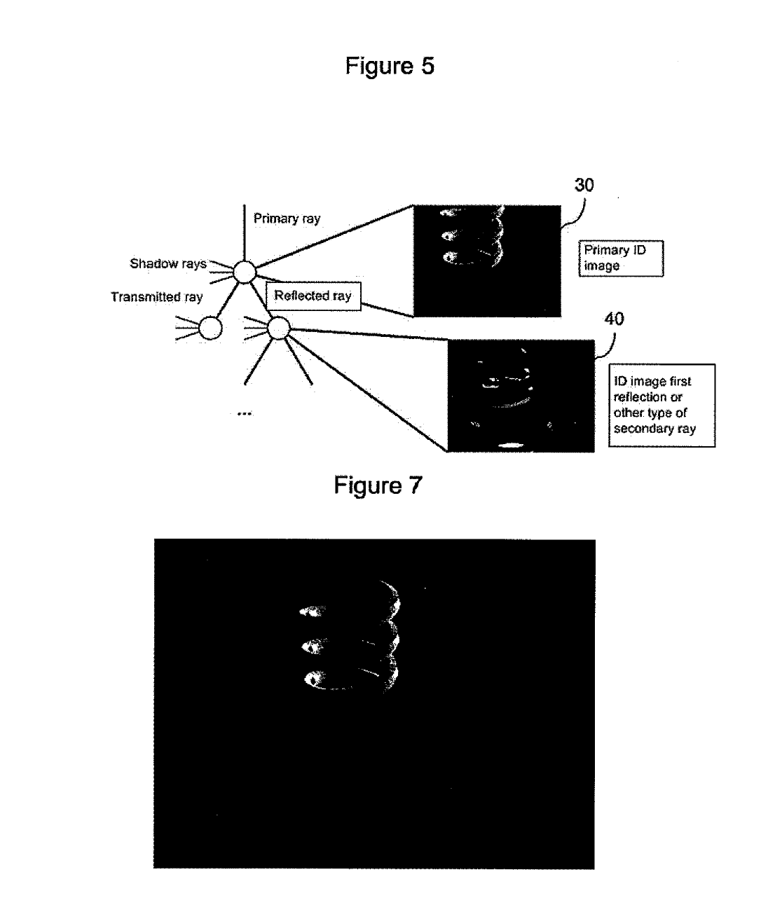

FIG. 5 is a graph synthesizing ray propagation;

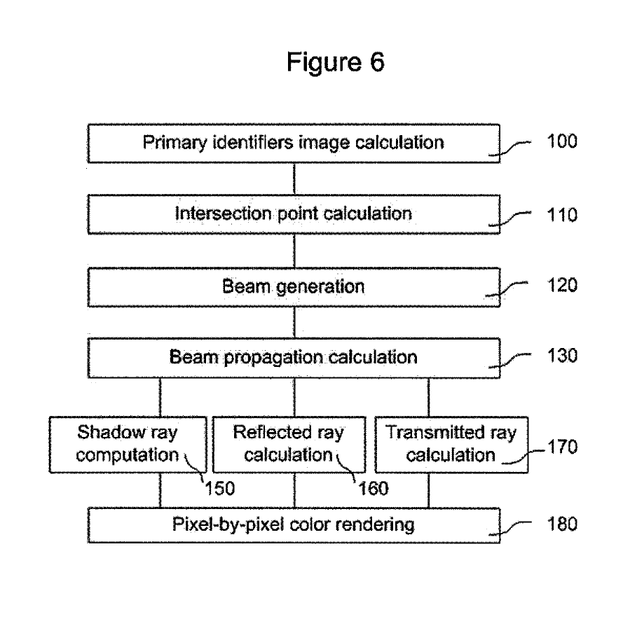

FIG. 6 is a flow chart of this invention;

FIG. 7 illustrates a graphic rendering by the graphics card for obtaining visible mesh triangles;

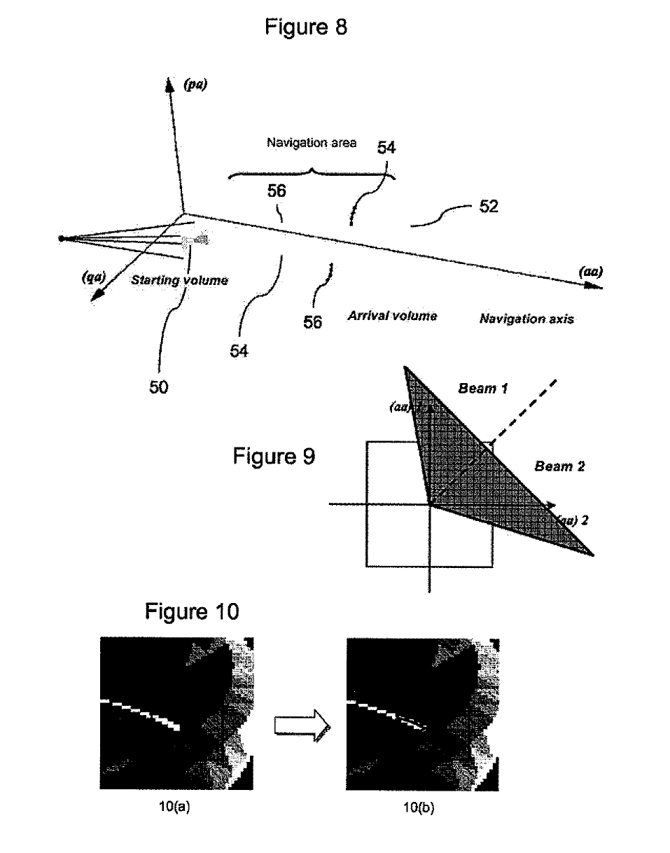

FIGS. 8 to 10 illustrate the structure of the beam according to this invention,

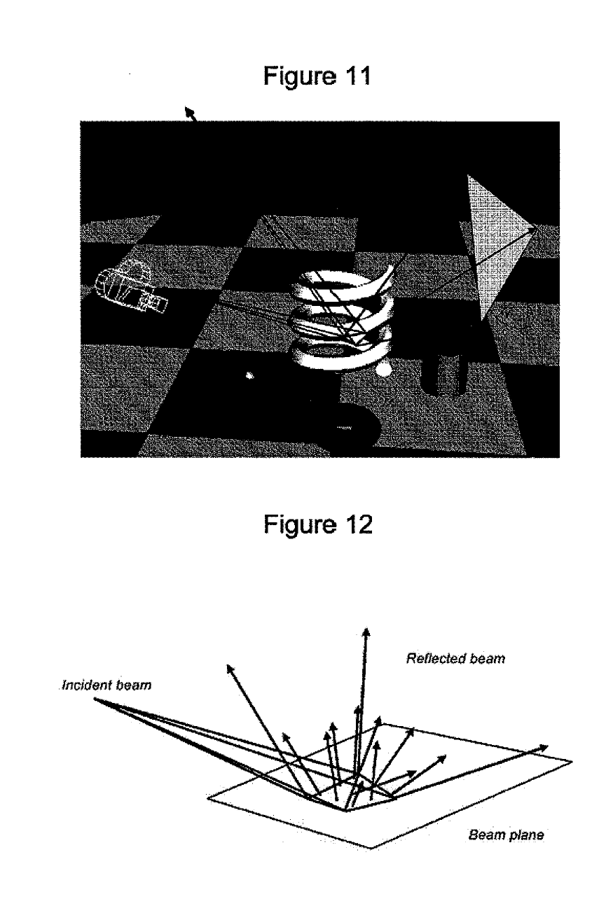

FIG. 11 illustrates beam propagation according to this invention;

FIG. 12 illustrates ray reflection in the case of relief texture surface;

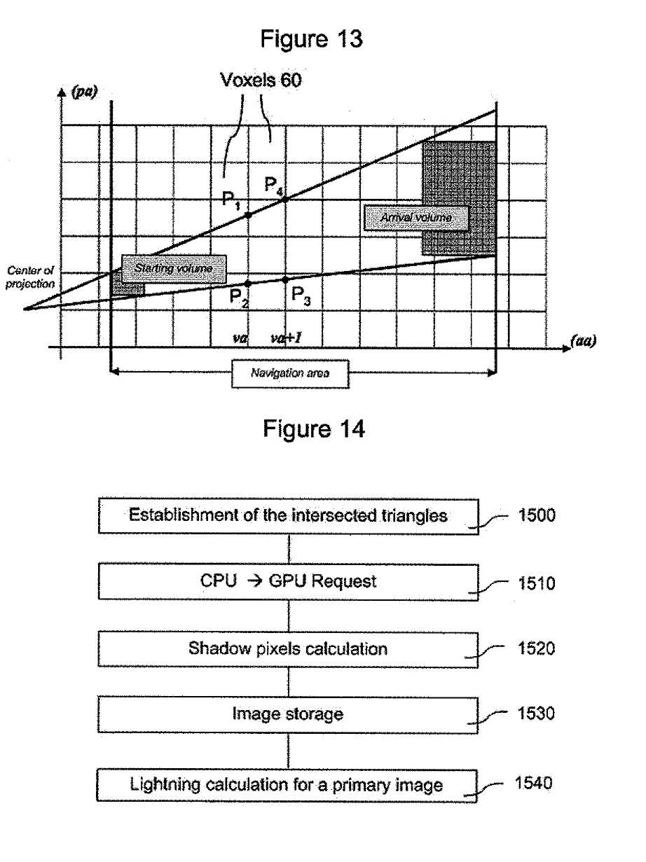

FIG. 13 represents an example of regular accelerating structure for implementing the invention;

FIG. 14 represents a flow chart to calculate the shadow ray in FIG. 6;

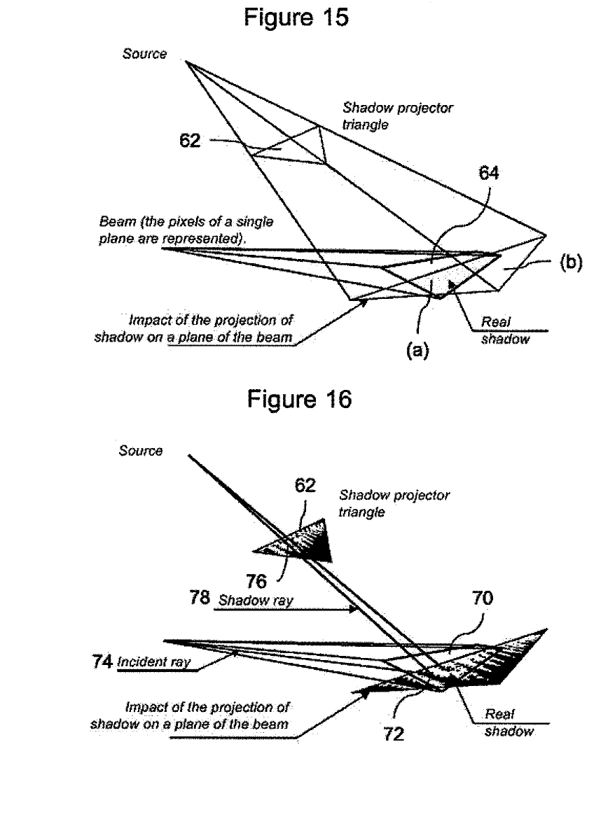

FIGS. 15 and 16 illustrate shadow calculation for this invention;

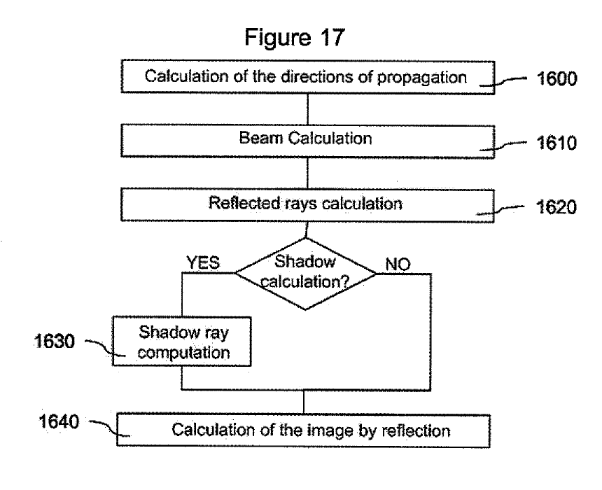

FIG. 17 represents a flow chart to calculate the reflected or transmitted ray in FIG. 6;

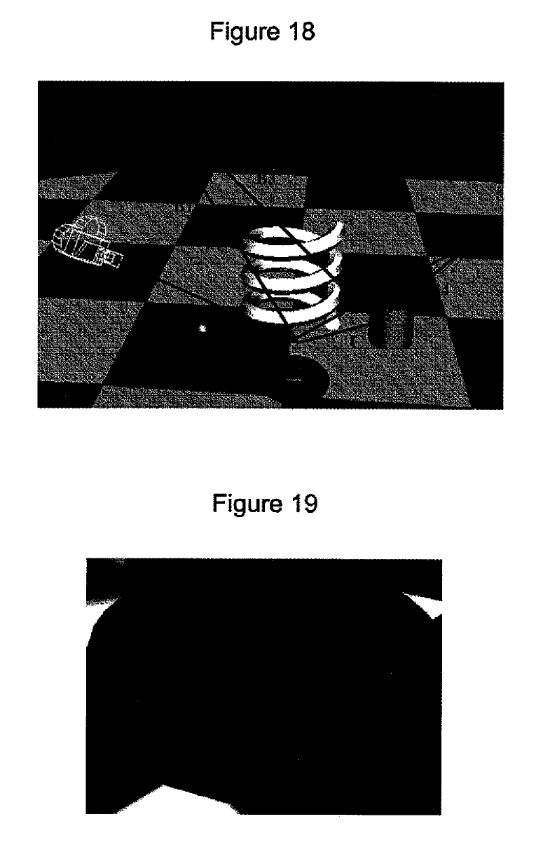

FIG. 18 illustrates the secondary rays of the ray tracing; and

FIG. 19 represents a torus for comparing performances between this inventions and the techniques of the prior art.

Color plates corresponding to plates 1/10, 3/10 and 10/10 have also been provided when filing of this application and are included with the file for a better understanding of the invention.

Referring to FIG. 4, a system for implementing the invention includes:
a general purpose processing module 10 enabling to resolve general purpose tasks, namely with random access memory (RAM) 12, for accessing and continuous modifying of the information contained therein. This block includes one or several processors 14 (CPUs) and may or may not be based on a unified memory.
another module of specialized processing 20 or GPU (graphics card) enabling to run specialized tasks in parallel. The data received by this block via a transfer bus (22) produce, via processing units 24, a result written in a memory 26 on module 2 itself, and
a bidirectional transfer bus 22 between the two previously described entities, for transmitting commands from the general purpose block to the coprocessors, and for retrieving the results calculated by those.

Typically, a modern average machine contains one or several CPUs, a unified memory based system (except for L1 and L2 memory caches of each processor), and includes an AGP or PCI-E transfer bus to communicate with one or several GPUs. The GPUs calculate in parallel the tracing instructions sent to them via vertex or pixel shaders and write the results produced in the video memory. This video memory can be copied to the CPU memories if need be, or be directly used for display.

For future references, CPU 10 is called the general purpose calculation module and GPU 20 the specialized module.

The GPU includes elements that can generally be programmed for pixel processing and calculation of the images to be processed, and especially
vertex shaders allowing the implementation of graphic functions to modify the polygon vertices of an object (namely the vertex attributes) and thus transfer its representation into the image,
pixel shaders allowing the implementation of graphic functions to modify the illumination and surface effects resulting from the display of the object polygons (e.g. the texture). The pixel shader acts on the components (color, transparency, z-buffer depth) of each pixel, independently from other pixels and enables to modify the appearance of the objects to obtain a rendering closer to reality, the cache or z-buffer which is an additional memory to that used for pixel color storage, and which allows to associate a normalized Z coordinate to each pixel. It is namely used in the invention to memorize the visible mesh object or triangle (i.e. the one closest to the eye-point) in each pixel.

The CPU places in its RAM memories 12 the data defining the mesh triangles of the scene objects under the form of database linking an identifying data of each triangle with the three vertex coordinates in the space under consideration. Eventually, these data can be returned from a database into read-only memory.

The CPU also executes an applicative program as instructions to perform steps of the procedures described below. These instructions are organized in requests or “rendering passes” towards the GPU consisting in the generation of an image resulting from specific GPU calculations. Each cycle of “rendering passes” includes:
calculations performed by the CPU,
transmitting a request to the GPU for parallel calculations, generally on all the pixels and for all the beams,
the resolution by the GPU of the request tracing instructions,
eventually, the retrieval by the CPU of the calculations results, then
eventually, one or several instructions of the composition of the final image integrating all the pixel color data calculated during the various rendering passes,
the display of the final computer-generated image by the GPU.

Several rendering passes can be framed in order to optimize processings, starting by—e.g.—the CPU calculations of a new pass while the GPU calculates the image of the previous one. CPU and GPU are thus parallelized.

FIG. 5 illustrates the ray tree calculated during this invention. This tree is predetermined and includes, for example a primary ray directly produced by the camera, shadow rays at the first obstacle (number according to the number of light sources), a transmitted ray, a reflected ray, and shadow rays corresponding to each obstacle level touched by the rays.

Conventional ray tracing programs generally calculate a ray tree by emitted primary ray. The total tree has a fixed depth and only a subpart of it is evaluated, according to the trajectory of the rays in the base. As for this invention, it generates rendering passes to enable advancing in the ray tree resolution, globally, for the entire scene, level by level.

This invention approaches the resolution of this ray tree depth by depth. Thus, it can be planned to recalculate the ray beans for each of the tree depths.

In reference to FIG. 6, the various steps composing the invention will be described in further details.

Primary Ray Calculation

### Calculation of the Primary Identifiers 100 Image

| CPU | Bus | GPU |
|---|---|---|
| Transmitting the list of | → Triangle | Resolution of the trace with a |
| the object triangles to be | lists | z-buffer material rendering. |
| traced (classic material | | Writing the identifier of each |
| rendering). | | triangle for each pixel of the |
| | | image. |
| CPU result retrieval: For | ← Transferring | Storing the transferred image. |
| each pixel of the image, | a pixel image | |
| the triangle first met by | to screen | |
| each primary ray is thus | resolution. | |
| available. | | |

The CPU 10 accesses in RAM memory 12 the data of the mesh triangles (for each triangle, unique identification number and coordinates of the three vertices). Then it transmits a tracing request to the GPU 20 via bus 22 including the list of the triangles. This tracing instruction is sent using the usual graphic API (application program interfaces) such as Direct3D or OpenGL (commercial names). These are tracing instructions for geometric primitives by the board, which does not limit the tracing instructions to triangles only. In addition, most often objects to be traced to the board, which have been loaded beforehand on to the board, are directly indicated.

This tracing resolution is realized by a material rendering (material rendering: calculations performed not by a program but by parallelized material components, typically in a graphics card) relying on using the z-buffer memory (to determine, for example, the triangle nearest from the eye-point and thus to be displayed for each pixel). In this resolution, the GPU writes the identification number for each triangle to be displayed for each pixel of the image, e.g., if a pixel (i, j) should display a triangle x, then the color value allocated to this pixel is x. The colors of these pixels are commonly coded according to the R8G8B8A8 format (Red 8 bits, Green 8 bits, Blue 8 bits, Alpha 8 bits) allowing the indexing of a large number of triangles. The image obtained, illustrated in FIG. 7, thus allocates a color to each of the pixels. This color is independent from the real color of the objects of the scene but representative of the identification number of the triangle to be displayed at this pixel.

This primary identifiers 30 image, generally of the same resolution as the screen, is stored in the GPU video memory then transferred to the CPU which has now for each pixel the triangle that is first met by each primary ray.

Back to FIG. 5, other similar identifier images are generated from the tracing sequence results transmitted to the GPU. Two types of identifier images, generated at different depths in the ray tree, are identified.
identifier image 30 generated by resolving the propagation of the primary rays,
identifier image 40 generated by resolving the intersection calculations between secondary rays and geometry.

These identifier images are used to set the beams, and constitute the state of ray tracing for the entire scene at a depth given in the ray tree. Resolving the calculation of beam tracing generates the next identifier image in the ray tree for the scene.

it is noteworthy that the shadow rays do not generate additional images, in so far as they are leaves in the arborescence of the rays.

### Calculation of Intersecting Points 110

Knowing a triangle identifier, the equation of the primary ray (eye-point 1+ray directing vector), the ray-triangle intersection is easily calculated (limited to a line-plane intersection): the intersecting points of the primary rays with the scene geometry are thus available.

An alternative may be considered: The CPU transmits the list of the triangles of the objects to be traced to the GPU. Resolving GPU tracing directly includes the calculation of the ray intersecting point matching each pixel with the triangle traced at this pixel. The color components of each pixel are then coded over a greater number of bits, for example, R32G32B32, R24G24B24 or R16G16B16 with a floating coordinate of the intersecting point by color component. Then the CPU retrieves the results: then for each pixel, the intersecting point touched by the ray is available. With this alternative, there is a loss of numeric precision, all the more important since the color components are coded on few bits, given that the format of base storage on the CPU generally uses floating values encoded in 32 or 64 bits. In addition, this alternative is not optimized in that it clearly requires higher performances from bus 22.

### Beam 120 Construction

The beam is used to group a certain number of rays. This initial assembling is calculated from the previously calculated image of primary identifiers 30.

Generally, in reference to FIG. 8, the beam is a simple truncated pyramid defined by a zone 50 of the space containing the starting points of the included rays, and a zone 52 of the space containing the possible arrival points of the rays if they are known, or a zone including the possible end points of the rays. The total space zone covered by the beam is delimited by the following plans:
min/max value according to navigation axis (aa), for example, distance from the camera to the first object encountered in the space (min) and distance from the camera to the most distant meshing element (max),
left and right faces 54, parallel to vertical axis (pa),
upper and lower faces 56, parallel to horizontal axis (qa),

If the beam covers several navigation axes, several beams are defined as illustrated by FIG. 9.

Identifier image 30 is arbitrarily cut in rectangular zones (n×m pixels) to serve as basis for assembling of pixels into beams. The choice of the size of this cut enables to modulate the number of beams ultimately generated. It is better not to generate too large starting beam volumes for the beams' navigation performances. For example 32×32 pixels zones are used. With reference to FIG. 10a, this 32×32 zone defines a beam starting zone. With 32×32 pixel groups on this image, the CPU regroups all the points matching rays which intersections with the geometry are spatially neighbors in order to define the beam starting volume.

For example, we can choose the first point of the zone under consideration and assemble with it all points that are within a pre-determined distance (for example, a distance substantially equal to the size of an accelerating structure element, i.e. a voxel). The procedure is then repeated with all the points that have not been so spatially assembled, until all of them are grouped or remain isolated, without neighbors matching the assembling criterion.

FIG. 10b represents the creation of three beams A, B and C on this n×m pixel elementary zone. According to the applied criteria, a much larger number of beams can be created. On the example of FIG. 10b, beam C could be subdivided in two beams to account for the two main orientations of the spring wire faces. In order to do this, it can be agreed that the CPU determines, at the same time as the intersecting points, the re-emission directions (transmission, reflection, . . . ) so as to also group the rays according to these criteria.

Beam Propagation

### Calculation of Beam Propagation 130

Therefore, it is appropriate for the CPU to determine each beam propagation. Two beam propagation behaviors are identified according to their nature:
the beams intervening in resolving shadow calculations, and
the beams corresponding to other rays (reflection, transmission, . . . ).

Referring to FIG. 11, for beams used to calculate shadows, the propagation of the beam is simply defined by its convergence towards the light source volume itself, all rays of the beam must reach it.

In case of beams used for other rays—reflections, transparency, global illumination—, the beam ending zone can only be defined from the propagation direction of each of its constitutive rays. In most cases, the CPU sends a request to the GPU to calculate perpendiculars to the plane defining the visible meshing elements of the identifier image 30. In return, the CPU having this perpendicular to the planes met by the beam rays can determine each propagated ray (simple reflection or transmission in a different propagation index medium), and thus calculate the beam tracing including the propagated rays, e.g. reflected ray 2 is defined by the most extreme reflected rays of incident primary beam A.

An alternative consists in sending a request to the GPU for calculating the ray re-emission directions and not just the perpendicular to the surface to account for. In return, the CPU then has the ray propagation direction for the type of propagation required.

Assuming that a volume including the scene is defined (typically using the max value as previously defined), the intersections of the border rays of beam 2 with such volume define a possible planar impact area for the rays contained within the beam. Such area serves as end area 52 in positioning the acceleration structure.

In case of surface or texture of objects with particular properties, for example a relief texture (FIG. 12), the reflected ray distribution is disturbed on the pixels making the beam starting area. Practically, it is the perpendicular at the surface that is disturbed. The distribution of the directions being retrieved on the CPU after GPU calculation (either through perpendiculars or directly), it is possible to choose the “extremal” directions to define the edges of the pyramid of a reflected or transmitted beam: It is the envelope of all the directions considered. Eventually, if the extreme rays are too divergent, a subdivision of the beam into coherent ray beams can be considered.

Computation of Shadow Ray 150

By this, we are interested in determining whether what is seen through the camera is enlightened. In order to do that, it is necessary to calculate 150 the shadow rays, which will enable to determine whether a light source should contribute to the pixel color calculation of the triangles intersected by the primary beam. This step 150 is described in further details with reference to FIG. 14.

### Determining the Intersected Triangles 1500

For each beam assembling a certain number of spatially close rays, the triangles intersected by the beam are calculated using an accelerating structure. It consists, for the CPU, in applying the accelerating structure to beam 1 of FIG. 11, then to perform incremental calculations for each of the beam sections of the intersected triangles.

For more details regarding accelerating structures, examples of accelerating structures are offered in the previously cited scientific publication by M. Chang.

With reference to FIG. 13, the scene space is divided in voxels (volumetric pixels) 60, preferably according to a regular hierarchy.

For the two planes comprising the navigation axes (aa, pa) and (aa, qa), the beam section in the basis is calculated following crescents (aa), at the voxels border. This is materialized by four points P1 to P4 in FIG. 13. The sections on both planes delimit the voxel area crossed by the beam between va and va+1 (the beam slide [va, va+1] in the basis). Then, the CPU is utilizing the accelerating structure to calculate incrementally (section by section along the beam propagation orientation) the intersection of the beam with the scene elements. This structure applies to all propagated beams (shadows, reflections, . . . )

All the way through the virtual image elaboration cycles, such accelerating structure is updated to take into account the scene modifications (i.e. a moving object). Such modifications can lead to redefining the accelerating structure and/or resetting the content of certain voxels for which the contained meshing elements would have changed.

Thus, recouped from processing the beam by the accelerating structure, the identification numbers of the triangles met by each beam are stored and associated to the image area that served to define the beam. Each shadow projecting triangle was found by a beam produced from rays starting on triangles intersected by rays. Each shadow projecting triangle is linked to the identification numbers of the shadow receiving triangles in order to effectively trace the triangle projection only for the pixels for which the shadow projecting triangle projects a shadow on the correct receptor. This enables to restrict the projection area to pixels that need to receive it.

This very efficient method goes against the techniques of prior arts that aimed at determining the nearest intersection, the cell within which the ray is found being entirely scanned in order to find with certainty the triangle that first crosses the ray. In this invention, not only the nearest intersection is available but also all the others, i.e. triangles “hidden” on the beam trajectory. These triangles will namely serve for computing shadow projections.

### Sending the Request for Shadow Image Tracing 1510

| CPU | Bus | GPU |
|---|---|---|
| Request for each triangle pixel to | → | Projection of triangles on the planes |
| be traced that can cast shadow for | Lists of triangles, receptor | of the triangles receiving shadow: |
| the shadow ray matching this pixel | identifiers, equations for | The vertex shader realizes point |
| | receptor triangle planes | projections, the pixel shader allows |
| | | shadow application only if the |
| | | receptor identifier is equal to the |
| | | primary image identifier for the traced |
| | | pixel. |

Then, the CPU sends a request to the GPU for tracing the shadow image of the primary rays. To that end, it sends the list of triangles, identification numbers of the triangles intersected for each shadow propagated beam in the accelerating structure, and the intersected triangle vertices.

### Shadow Pixels Calculation 1520

Referring to FIG. 15, the GPU realizes the projection of the shadow projecting triangles (i.e. those intersected by the shadow beam and determined by the accelerating structure) on the triangles intersected by the primary beam and visible on the final computer-generated image. To that end, the following steps are taken:
generally, the screen-size image receiving the shadows is white (no shadows),
the shadow projecting triangle 62 is traced in its original space, and the GPU board transforms the positions of the points by projecting them on the plane of the shadow receiving beam with a vertex shader. This shadow receiving beam plane is understood as being a set of the primary ray intersecting points which are coplanar, i.e. constituting a surface 64 on which the shadow might be projected. Therefore the calculation procedure will be repeated for all the beam planes, i.e. all the surfaces forming the primary beam intersecting points,
the color of the traced pixels is black if and only if the identification number of the triangle receiving triangle projection 62 at the pixel in question is the same as the identification number of beam plane 64 for which it was found that the triangle is shadow projecting (identification number of the pixel involved in the primary identifier image) (case a in FIG. 15). Otherwise, the pixel color is left intact (case b in FIG. 15).

The equality test for the identification numbers enables shadow “clipping”. It provides for each pixel, on one hand, the identifier image that was used to calculate the beams, and, on the other hand, the triangles that were assembled by the propagation of these beams. The equality test for the identification numbers enables to color effectively only the pixels that are actually in the shadow, the projection “spilling-over” the actual area to shadow, since it is calculated for an infinitely large receiving plane.

In this way, it has never been necessary to explicitly calculate the intersection of a ray and a triangle. The beams have enabled the transformation of a shadow calculation per ray in a succession of triangle projection performed by the graphics card. Moreover, the transformation of a shadow calculation into triangle tracing sequence naturally blends in contemporary GPU architectures. Therefore, tracing performances are excellent, and enable to reach acceleration factors in the order of ×100 as compared to traditional ray tracing techniques.

### Image Storage 1530

The storage follows, by the GPU, of the image containing the shadows to be applied for each pixel for such light source.

Step 150 is reiterated for the number of light sources present in the scene.

In case of textured object shadows illustrated in FIG. 16, a more generic solution can be used to account for the degrees of shadow. The following steps are then realized:
the screen-size image receiving the shadows is colored in white (no shadows),
an area 70 covering the pixels of the beam plane is traced for each shadow projecting triangle 62,
the vertex shader calculates intersecting point 72 of incident ray 74 on the beam plane, the pixel shader calculates intersection 76 of shadow ray 78 with triangle 62. The identification number equality test between intersected triangle 62 and the shadow projecting triangles calculated by the accelerating structure enables to only validate the intersection calculation for the pixels that effectively receive shadow, as in the case of the previous method,
eventually, the shadow value is nuanced according to the transmission properties of shadow projecting triangle 62.

### Lighting Calculation for Primary Image 1540

The previous step enables to determine in each pixel of the image if a shadow should be applied or not. In fact, applying a shadow corresponds to not illuminate the pixel. The shadow image calculated previously is used in this pass as a mask to only illuminate the pixels not receiving a shadow.

| CPU | Bus | GPU |
|---|---|---|
| Sending the list of | → | Tracing resolution with |
| objects triangles to be traced | Lists of | a z-buffer material rendering. |
| (in classical material | triangles | The shadow image enables to |
| rendering). | | apply illumination correct. |
| | | The color is calculated by the |
| | | shaders describing the |
| | | materials and visual properties |
| | | of the traced objects. |

During the tracing of the computer-generated image, the GPU take into account the shadows stored during Step 1530. It initializes then the video rendering memory with the result of the trace: IMAGE 1.

Then, it calculates, using the shaders, the colors of each of the pixels, taking the shadows into account.

At this stage, the scene is traced with shadows for each illumination present (pixels color). The image is already complete for “direct” shadows and colors (i.e. without taking into account for example reflection or transmission components. The following steps will complete the result: adding reflections or transparencies, global illumination, or other.

Secondary Rays 160, 170

The reflected and transmitted rays can be processed in a similar way since only their propagation characteristics (reflection against transmission) differ.

Therefore we focus on the reflected rays (beam 2, FIG. 11) referring to FIG. 17, and as illustrated in FIG. 18. This latter shows ray C propagated by primary ray A reflection, said ray C having namely two shadow rays B3 and B4 by propagation.

In order to determine what the objects found by the reflected rays are, it is necessary to calculate—beforehand—their direction of propagation (1600).

| CPU | Bus | GPU |
|---|---|---|
| Sending the list of object | → | Resolution of the trace with a |
| triangles to be traced (in | Lists of | z-buffer material rendering. |
| classical material | triangles | The shaders calculate the |
| rendering). | | reflected direction for each |
| | | pixel. The points touched by |
| | | the rays are also calculated. |
| Retrieval of the reflected | <== | Storage of the direction image |
| directions for each ray. | Transfer of a | on the GPU, at full resolution. |
| | pixel image at | Storage of the image of the |
| | screen | rays' starting points. |
| | resolution. | |

The CPU sends a request to the GPU to calculate the directions of reflection by transmitting the triangles visible in each pixel. For each pixel of the image, the GPU proceeds to calculate the direction of reflection of the incident ray for each pixel, considering the surface properties of the object being touched.

These data are stored under as image: for each pixel corresponds a tridimensional direction which is stored in the color components of the pixel as well as eventually, a starting reflection point (beam intersecting point).

The data transferred back to the CPU are stored there.

Then, it becomes possible to calculate the beams and to realise their propagation in the accelerating structure (1610). We can reuse the same beams as those calculated previously for the shadow ray. However, some reflections can lead to a beam separation into several sub-beams (case of a wall corner hit by a same beam and cutting it in two from the ray re-emission direction point of view). Such step 1610 therefore enables to redefine said beams if necessary.

The beams can be recalculated if necessary from the previously retrieved image which enables to take spatially close intersecting points into account by taking coherent re-emission directions (reflection directions, for example) into account.

Then, the accelerating structure is applied by the CPU to each beam to determine the triangles intersected by the reflected beam as in Step 1500. Such triangles can be called: second rank intersected triangles. For each beam, the set of second rank intersected triangles is thus registered.

Finally, the reflected rays are calculated (1620): what is the nearest triangle intersected by each reflected ray?

| CPU | Bus | GPU |
|---|---|---|
| Sending for each pixel the | => | Resolving the ray- |
| triangles found by the beam | List of triangles, | triangle intersections |
| matching the ray for said | traced by rectangle, | via shaders. |
| pixel. | emitter identifiers, | |
| Retrieval of the identifier | ← | GPU storage of the |
| image of the reflected | Transfer of a pixel | identifier image of the |
| triangles. | image at screen | triangles visible in |
| | resolution. | the reflections. |

It is a new rendering pass by the GPU.

The CPU sends to the GPU a request to calculate the intersections between the reflected rays and the second rank intersected triangles.

The resolution of this request is realized by the GPU shaders. For this purpose, the intersection distance on the ray is used as depth for the z-buffer, which enables to keep only the nearest triangle intersected in each pixel. The tracing method used is an indirect tracing method: each triangle to be tested is traced on the box that includes the pixels whose rays can hit this triangle. To apply the results to some pixels only of this box, the emitter identifier associated to the triangle is used, as well as the primary identifier image which allows in each pixel to consider the calculation as valid only if the two identifiers are identical. More specifically:
the screen-size image receiving the shadows is colored in black (no id), the depth of the associated z-buffer is set at 1.0f (maximal depth),
an area covering the pixels of the beam plane is traced for each triangle visible in the reflection.
the “vertex shader” calculates the intersecting point of the incident ray on the beam plane, as well as the direction of reflection.
the “pixel shader” calculates the intersecting point—if an actual intersection exists—between the triangle and the ray corresponding to each pixel. The length of the ray compared to its maximal possible length (dimensions of the sphere including the scene) with regards to the scene is written in the z-buffer. Therefore, only the first triangles crossing the reflected rays remain in the identifier image.

The image containing the ray starting points, and that containing their direction are used for the resolution. The tracing result is an identifier image of triangles: it is reflected image 40 (FIG. 5).

This secondary identifier image is stored in the GPU memory and then transferred to the CPU, which now has identification numbers of the triangles visible by reflection at each of the pixels of the image.

### Calculating the Shadow Ray in a Reflected Image 1630

If more definition is needed in the rendering, it is possible to calculate the shadow ray in the reflected image.

In order to do that, it is possible to follow the procedure from Step 150, provided the following information are available, which can easily be calculated, for example in two GPU rendering passes:
intersecting point of the reflected rays,
identifier image of the reflected rays,

The intersecting points can be determined in several ways:
by retrieving the image of the reflected directions at full resolution, and by calculating the lines-planes intersections for each ray, exactly in the same way as for the primary ray,
by using an additional tracing pass for calculating the intersection coordinates of the points hit by the reflected rays, and by retrieving this information in the CPU.

It is notable that the identifier image has already been calculated during the previous beam propagation, in case of a reflection or transmission.

In this way the shadow information of the triangles seen in reflection are calculated, a kind of light mask that will be used for restituting the colors of the triangles seen in reflection.

### Calculating the Illumination for the Reflected Image 1640

As for previously mentioned Step 1540, this step consists in calculating the colors of the pixels seen in reflection while taking into account, if possible, the shadows sustained by such pixels seen in reflection. Due to the reflection (or transmission), it is an indirect light.

This step is realized by the GPU, and for calculating the indirect illumination, the GPU should know:
The starting point image of the rays (previously calculated),
The direction image of the rays (previously calculated),
The identifier image of the light receiving triangles, corresponding to the identifier image of the triangles visible in the reflections.

With this information, the GPU shaders provide the calculation of illumination using the properties of the materials of the objects visible in the reflection.

Starting from the secondary identifier image, the color of the elements visible in the reflection is determined, taking namely shadow and indirect illumination rays into account. The example in FIG. 18 illustrates the tracing of rays B3 and B4. The procedure is similar to that used to trace shadows:
The screen-size image receiving the reflected color is colored in black.
A zone covering the pixels of each triangle visible in the reflected id image is traced for said triangle.
The “vertex shader” calculates the intersecting point and the direction of reflection of the ray incident to the beam plane.
The “pixel shader” calculates the intersection of the reflected ray with the triangle. The impact point of the intersection enables to calculate B3 and B4. The equality test of the identifiers allows to validating the calculation of intersection only for the pixels matching the triangle whose illumination is being calculated and which is not necessarily visible for all the pixels of the quadrilateral traced.

The image so obtained includes for each one of the visible pixels, the color of the element seen in reflection (taking the shadow into account).

It is understood that this calculation procedure on reflected ray can be applied to transmitted rays, and to upper rank reflected rays (i.e. sustaining numerous reflections or transmissions). Since the invention operates depth by depth in the ray arborescence, it is appropriate to recalculate for each propagation, the new beams best matching the propagation (identifier image generation as well as re-emissions direction), and to apply the accelerating structure to the beams to restrict the space of the meshing triangles to be studied, then finally to calculate the intersections of the propagated beam with this restricted set. The recursivity principle applies from one depth to another, and from one type of propagation to another.

In this way, a set of images of the scene is obtained, including the pixel color components for reflection, transmission (of first order or consequent). For example, for a depth of two reflections and transmissions, the images produced at this step are:
first reflection image taking shadows into account,
   second reflection image subsequent to first reflection,
   transmission image subsequent to first reflection,
first transmission image taking shadows into account,
   reflection image subsequent to first transmission,
   second transmission image subsequent to first reflection,

Final Rendering 180

The GPU performs the computer-generation of the final image from the different images calculated during the previously described steps, by summing and modulating each of these images.
Step 1540 produced an image containing the result directly visible by the camera of the elements of the scene, taking the shadows and the colors of these elements into account.
Each of the recursive steps 1640 produces an image containing the visible result for the ray under consideration in the arborescence of the ray propagated for the scene, taking into account the shadows at this level.

These images are added pixel by pixel and modulated among themselves according to the properties of the materials that constitute the elements of the scene (reflection or transmission coefficients are taken into account for a more precise rendering).

This invention offers noticeable performances as compared to other techniques of the previous art. Thus, the calculation performances for the image in FIG. 19 between this invention and the marketed Mental Ray solution (http://www.mentalimages.com) are summarized in the following table.

| Resolution | Mental Ray (sec) | RED (sec) | Acceleration |
|---|---|---|---|
| 640 × 480 | 16 | 0.25 | ×63 |
| 800 × 600 | 23 | 0.32 | ×70 |
| 1024 × 768 | 37 | 0.44 | ×82 |
| 1280 × 1024 | 60 | 0.68 | ×87 |

This invention applies to image rendering, by enabling it namely to calculate more complex images, faster than the existing technologies, at equal quality level. It allows to control between quality and speed to meet the needs in several sectors.

In particular, the following sectors use computer-generated images as the core of the trade: simulation (flight simulation for example), computer-assisted design (design centers), video games, movie post-production (special effects) or computer-generated animations.

1. A method for preparing a computer-generated image of a scene from a camera, said scene comprising a plurality of objects defined by elementary meshes stored in a database, said method comprising:
defining a plurality of rays produced by said camera towards an observed scene, wherein the plurality of rays are defined by a central processing unit;
processing said plurality of rays, wherein processing said plurality of rays comprises assembling said plurality of rays into beams, wherein rays of a same beam comprise spatially coherent intersecting points with meshing elements;
propagating said beams by determining, for each of said propagated beams, a subset of the meshing elements intersected by said propagated beam, and calculating, for each of said propagated beams, the intersections between said subset of the meshing elements and the propagated beam rays, wherein the calculation is performed by a graphics processing unit; and
generating said image of the scene after completion of said propagation.

2. The method for preparing a computer-generated image according to claim 1, wherein determining the subset of the meshing elements is realized by a central processing unit CPU connected to said database.

3. The method for preparing a computer-generated image according to claim 1, wherein determining the subset of the meshing elements includes propagating a the beam according to an accelerating structure of said intersected meshing elements, said accelerating structure being a simple spatial decomposition of a space associated with the scene, and wherein said subset comprises the set of said meshing elements intersected by the beam along the accelerating structure.

4. The method for preparing a computer-generated image according to claim 1, wherein, for a computer-generated image represented by a plurality of pixels, generating said image of the scene comprises generating at most one ray crossing each pixel of the plurality of pixels is generated.

5. The method for preparing a computer-generated image according to claim 1, wherein, for a computer-generated image represented by a plurality of pixels, generating said image of the scene comprises generating a set of rays crossing each of the plurality of pixels.

6. The method for preparing a computer-generated image according to claim 4, wherein said processing of rays comprises, prior to the assembling of the rays into beams:
generating, by said graphics processing unit, an identifier image of the scene, said identifier image comprising:
a second plurality of pixels matching said plurality of pixels representing the computer-generated image, and
in each of the second plurality of pixels, identification data of at least one one meshing element visible for a corresponding pixel to from the plurality of pixels representing the computer-generated image;
determining, for each pixel of the second plurality of pixels associated with the identifier image that is crossed by at least one primary ray, at least one intersecting point of said primary ray crossing the pixel with said meshing elements for which identification data are recorded in pixel coordinates of said image, when such identification data exist for the corresponding pixel;
assembling the second plurality of pixels, wherein said intersecting points previously determined are spatially coherent;
wherein said beam assembling comprises assembling, within a same beam, the rays associated with the assembled pixels.

7. The method for preparing a computer-generated image according to claim 1, wherein said propagated beams comprise at least one selected from the group consisting of transmitted beams, reflected beams, and shadow beams.

8. The method for preparing a computer-generated image according to claim 7, wherein the propagation of said beams is applied recursively to each one of said transmitted and reflected beams.

9. The method for preparing a computer-generated image according to claim 7, further comprising:
processing, recursively at each new propagation, the propagated rays to assemble them into beams, and
propagating the beams by determining, for each beam, a subset of meshing elements intersection by said propagated beam, and calculating, for each beam, the intersections between the subset of meshing elements and the propagated beam rays,
wherein the processing is performed by the central unit.

10. The method for preparing a computer-generated image according to claim 7, further comprising:
dividing a propagated beam into a plurality of sub-beams, when said intersections calculated are not spatially coherent,
wherein the plurality of sub-beams are propagated by assembling the rays for which the intersections calculated are spatially coherent.

11. The method for preparing a computer-generated image according to claim 7, further comprising:
dividing a transmitted or reflected propagated beam presenting non-coherent rays into a plurality of sub-beams.

12. Computer software including a plurality of instructions executable on a computer, and capable of performing a method for preparing a computer-generated image of a scene from a camera, said scene comprising a plurality of objects defined by elementary meshes stored in a database, said method comprising:
defining a plurality of rays produced by said camera towards an observed scene, wherein the plurality of rays are defined by a central processing unit;
processing said plurality of rays, wherein processing said plurality of rays comprises assembling said plurality of rays into beams, wherein rays of a same beam comprise spatially coherent intersecting points with meshing elements;
propagating said beams by determining, for each of said propagated beams, a subset of the meshing elements intersected by said propagated beam, and calculating, for each of said propagated beams, the intersections between said subset of the meshing elements and the propagated beam rays, wherein the calculation is performed by a graphics processing unit; and
generating said image of the scene after completion of said propagation.

13. (canceled)

14. A system for implementing a method for preparing a computer-generated image of a scene from a camera, said scene comprising a plurality of objects defined by elementary meshes stored in a database, wherein the system comprises:
at least one central processing unit linked to at least one storage memory; and at least one graphics processing unit linked to said central processing unit by a bus,
wherein said central processing unit comprises:
means capable of generating rays produced by said camera towards said observed scene,
means capable of assembling said rays into beams comprising intersecting points with meshing elements that are spatially coherent, and
means capable of determining the propagation of said beams, and of determining, for each beam propagated, a subset of all meshing elements that intersect with said propagated beam, and
wherein said graphics processing unit comprises:
means capable of calculating, for each of said propagated beams, the intersections between the subset of meshing elements and said propagated rays, and
means capable of generating the image of the scene using said propagated beams.
